(19) United States
(12) Patent Application Publication
(10) Pub. No.: US 2026/0265003 A1
(43) Pub. Date: Sep. 10, 2026

(54) ROTATABLE LINEAR ACTUATOR, GRIPPING DEVICES, AND OBJECT HANDLING SYSTEM

(71) Applicant: ATS Corporation, Cambridge (CA)

(72) Inventors: Roger Hogan, Cambridge (CA); Blake Robert Lambert, Cambridge (CA); Matthew Visser, Cambridge (CA)

(21) Appl. No.: 19/551,524

(22) Filed: Feb. 26, 2026

Related U.S. Application Data
(63) Continuation-in-part of application No. 18/368,783, filed on Sep. 15, 2023.
(60) Provisional application No. 63/407,025, filed on Sep. 15, 2022.

(51) Int. Cl. B65G 47/52; B25J 9/00; B25J 9/12; B25J 15/00; B25J 15/08; B65G 47/90; H02K 41/02

(52) U.S. Cl. CPC B65G 47/52; B25J 9/0084; B25J 9/0093; B25J 9/123; B25J 15/0057; B25J 15/08; B65G 47/902; B65G 47/905; H02K 41/02

(57) ABSTRACT

An object handling system and a method of operating the object handling system are disclosed for facilitating object handoff between gripping devices on two different machines, such as between a linear motor conveyor system and a rotary dial. In one aspect, an object handling system comprises: a rotary dial defining a periphery; a plurality of first gripping devices supported by the rotary dial at circumferentially spaced locations about the periphery; a linear motor conveyor system comprising one or more second gripping devices arranged thereon; and a control system configured to control actuation of the plurality of first gripping devices and the one or more second gripping devices to grip and to release an object in synchronization with movement of the rotary dial and the linear motor conveyor system, and to enable object handoff between a first gripping device and a second gripping device.

### CROSS-REFERENCE TO RELATED APPLICATIONS

This application is a continuation-in-part of U.S. patent application Ser. No. 18/368,783, filed on Sep. 15, 2023, which claims priority to U.S. Provisional Patent Application No. 63/407,025, filed on Sep. 15, 2022, the entire contents of which is incorporated by reference herein for all purposes.

### TECHNICAL FIELD

The present disclosure relates to linear actuators, and in particular to rotatable linear actuators, as well as gripping devices and object handling systems.

### BACKGROUND

There are several applications where it would be desirable to rotate a linear actuator, particularly in manufacturing and quality control applications. However, rotating a linear actuator requires complex designs to accommodate the rotating parts. In situations where only small rotations are desired, such as less than 180 degree rotations, wiring to the actuator components can generally be designed to accommodate such rotation. However, if a larger degree of rotation is desired the wiring can generally not be designed to accommodate such rotation, let alone if a 360 degree rotation is performed or if multiple 360 degree rotations are performed.

As one example, gripping devices are used in manufacturing and quality control applications to grab an object and move the object from one location to another as well as to hold the object for inspection. To grab the object, a gripping unit of the gripping device is linearly actuated. To move the object and to facilitate inspection of the object, it would be beneficial to rotate the object while being held by the gripper unit. Further, in particular for smaller objects such as vials or syringes, during the manufacturing process the ability to move and reposition the objects along the assembly line requires accuracy and precision to avoid damage while maintaining efficiency. The overall size of the gripper and associated control hardware can limit the flexibility of the assembly line configuration and processing efficiency. It would be beneficial to have a rotatable linear actuator that could be incorporated into such gripping devices without requiring a complex design, and while also providing accuracy and precision of the actuation, which would help to allow for improved object handling.

Further, in automated manufacturing and quality control applications, objects travel on and are moved between various machines, which are typically in continuous motion. For example, one or more rotary dials may be used as a part of a labelling or inspection system; one or more linear motor conveyor systems may be used to move an object between different equipment or workstations; etc. In some implementations, such equipment/machines may comprise a gripper device that is used to grip an object that is being manufactured/inspected. There is no flexibility in classical continuous motion systems used in such manufacturing and quality control environments. That is, existing systems cannot skip a transfer between elements of the machines. It would be desirable to have an additional, alternative, and/or improved object handling system that facilitates object handoff between gripping devices on different components, such as between a continuous motion machine and a conveyor comprising independent servo axes with individual motion profiles.

Accordingly, an additional, alternative, and/or improved rotatable linear actuator, gripping device, and/or object handling system remains highly desirable.

### BRIEF DESCRIPTION OF THE DRAWINGS

Features and advantages of the present disclosure will become apparent from the following detailed description, taken in combination with the appended drawings, in which:

FIG. 1 shows a schematic drawing of an embodiment of a conveyor system that includes a track, made up of track sections, and moving elements;

FIGS. 2A and 2B show a representation of a conveying system with a gripping device using the rotatable linear actuator in accordance with the present disclosure arranged thereon;

FIGS. 3A and 3B show a representation of the gripping device using the rotatable linear actuator arranged on a support unit for mounting to the conveying system;

FIGS. 4A-E show the gripping device, comprising a gripping unit and a rotatable linear actuator in accordance with the present disclosure;

FIGS. 5A-5C show an example of an alternative gripping device comprising the rotatable linear actuator in accordance with the present disclosure;

FIG. 6A shows the drive shaft and magnets of the rotatable linear actuator;

FIG. 6B shows the drive shaft and magnets of the rotatable linear actuator, with the drive shaft coupled to the slotted hub of the gripping unit;

FIGS. 7A-D show a representation of transferring an object between gripping devices using the rotatable linear actuator in accordance with the present disclosure;

FIG. 8 shows a method of transferring an object between gripping devices using the rotatable linear actuator in accordance with the present disclosure;

FIGS. 9A and 9B show a side and top view of an object handling system in accordance with embodiments of the present disclosure comprising a linear motor conveyor system and a rotary dial;

FIGS. 10A and 10B show views of an object handoff within the object handling system;

FIG. 11A shows an isometric view of an exemplary gripping device installed on the linear motor conveyor system for gripping an object;

FIG. 11B shows a detailed view of the gripper fingers of the gripping device of FIG. 11A holding different object sizes; and

FIG. 12 depicts a schematic representation of an object handling system comprising two linear motor conveyor systems and a rotary dial.

It will be noted that throughout the appended drawings, like features are identified by like reference numerals.

### DETAILED DESCRIPTION

In accordance with one aspect of the present disclosure, a rotatable linear actuator is disclosed, comprising: an actuator body; a drive shaft arranged within the actuator body, the drive shaft having a longitudinal axis and configured to be linearly actuated along and rotatable around the longitudinal axis within the actuator body, wherein the drive shaft is configured to be coupled at a first end thereof to a linearly actuated component that is configured to receive linear and rotational movement; one or more permanent magnets coupled to the drive shaft and magnetized in a radial direction about the longitudinal axis; and one or more electric coils disposed within the actuator body around the one or more permanent magnets and configured to receive an electric current that interacts with a magnetic field of the one or more permanent magnets to generate an axial force to linearly actuate the drive shaft.

In some aspects, the rotatable linear actuator further comprises an electric motor disposed within the actuator body and configured to rotate a rotationally actuated component. The rotationally actuated component may also be the linearly actuated component or be coupled to the linearly actuated component.

In some aspects, the one or more permanent magnets are coupled to the drive shaft at a second end thereof.

In some aspects, the rotatable linear actuator comprises two permanent magnets and two corresponding electric coils each disposed around a respective of the two permanent magnets, wherein the two permanent magnets have opposite polarity.

In some aspects, the rotatable linear actuator further comprises a magnetically-permeable material disposed between the drive shaft and the one or more permanent magnets.

In some aspects, the rotatable linear actuator further comprises a bobbin arranged in the actuator body around the one or more permanent magnets, and wherein the one or more electric coils are wound around the bobbin.

In some aspects, the rotatable linear actuator further comprises a magnetically-permeable coil housing within which the one or more electric coils are disposed.

In some aspects, the one or more electric coils are disposed around the one or more permanent magnets and extend along the longitudinal axis of the drive shaft according to an actuation amount of the drive shaft.

In some aspects, the rotatable linear actuator further comprises a wireless transceiver configured to receive wireless instructions to control the rotatable linear actuator.

In some aspects, the rotatable linear actuator further comprises a sensor configured to measure a position of the drive shaft.

In accordance with another aspect of the present disclosure a gripping device is disclosed, comprising the rotatable linear actuator of any one of the above aspects, and a gripping unit that is configured to be rotated and to be actuated between open and closed positions by the drive shaft to grip an object.

In some aspects, the gripping unit comprises a hub that is the linearly actuated component coupled to the drive shaft, and two or more gripper jaws coupled to the hub and that actuate between the open and closed positions when the hub is linearly actuated by the drive shaft.

In some aspects, the hub comprises angled slots, and wherein the two or more gripper jaws are each coupled to a roller disposed within a respective angled slot, wherein linear actuation of the hub causes movement of the roller within the respective angled slot and actuation of the corresponding gripper jaw.

In some aspects, the two or more gripper jaws are pivotally coupled to a gripper housing, and wherein the gripper housing is the rotationally actuated component rotatable by the electric motor.

In some aspects, the two or more gripper jaws are coupled to a linear rail perpendicular to the longitudinal axis of the drive shaft.

In another aspect of the present disclosure, a conveying system is disclosed, comprising the gripping device of any one of the above aspects.

In another aspect of the present disclosure, a method of transferring an object between first and second gripping devices is disclosed, the first and second gripping devices each corresponding to the gripping device of any one of the above aspects, and the method comprising: gripping a first portion of the object with the gripping unit of the first gripping device; positioning the second gripping device at a second portion of the object; actuating the gripping unit of the second gripping device to grip the second portion of the object; and actuating the gripping unit of the first gripping device to release the first portion of the object.

In some aspects, positioning the second gripping device at the second portion of the object comprises moving the first gripping device and the second gripping device towards each other at a constant speed.

In some aspects, positioning the second gripping device at the second portion of the object comprises rotating at least one of the first and second gripping devices to a predetermined orientation.

In some aspects, the method further comprises rotating at least one of the first and second gripping devices while the gripping unit is being actuated.

In another aspect of the present disclosure, an object handling system is disclosed, comprising: a rotary dial defining a periphery; a plurality of first gripping devices supported by the rotary dial at circumferentially spaced locations about the periphery; a linear motor conveyor system comprising one or more second gripping devices arranged thereon; and a control system configured to control actuation of the plurality of first gripping devices and the one or more second gripping devices to grip and to release an object in synchronization with movement of the rotary dial and the linear motor conveyor system, and to enable object handoff between a first gripping device and a second gripping device, wherein the plurality of first gripping devices comprise a rotatable linear actuator coupled to a gripping unit that is configured to be rotated and to be actuated between open and closed positions by a drive shaft to grip the object.

In some aspects, the rotatable linear actuator comprises: an actuator body; the drive shaft arranged within the actuator body, the drive shaft having a longitudinal axis and configured to be linearly actuated along and rotatable around the longitudinal axis within the actuator body, wherein the drive shaft is configured to be coupled at a first end thereof to a linearly actuated component that is configured to receive linear and rotational movement; one or more permanent magnets coupled to the drive shaft and magnetized in a radial direction about the longitudinal axis; and one or more electric coils disposed within the actuator body around the one or more permanent magnets and configured to receive an electric current that interacts with a magnetic field of the one or more permanent magnets to generate an axial force to linearly actuate the drive shaft.

In some aspects, the object handling system further comprises an electric motor disposed within the actuator body and configured to rotate a rotationally actuated component.

In some aspects, the gripping unit comprises a hub that is the linearly actuated component coupled to the drive shaft, and two or more gripper jaws coupled to the hub and that actuate between the open and closed positions when the hub is linearly actuated by the drive shaft.

In some aspects, the hub comprises angled slots, and wherein the two or more gripper jaws are each coupled to a roller disposed within a respective angled slot, wherein linear actuation of the hub causes movement of the roller within the respective angled slot and actuation of the corresponding gripper jaw.

In some aspects, the two or more gripper jaws are pivotally coupled to a gripper housing, and wherein the gripper housing is rotationally actuated.

In some aspects, the two or more gripper jaws are coupled to a linear rail perpendicular to the longitudinal axis of the drive shaft.

In some aspects, the first and second gripping devices are the same type of gripping devices or are different types of gripping devices.

In some aspects, the one or more second gripping devices comprise a parallel gripping device with at least two linearly actuatable gripper fingers for gripping the object.

In some aspects, the one or more second gripping devices comprise a pivotable gripping device with at least two pivotably actuatable gripper fingers for gripping the object.

In some aspects, the second gripping devices are actuated via a cam coupled to a drive shaft.

In some aspects, the second gripping devices are actuated by interacting with the cam while the control system controls the second gripping devices to move along the track.

In some aspects, the cam is linearly actuatable to move into or out of a position for interacting with a cam follower of the second gripping devices.

In some aspects, the object is transferred from the linear motor conveyor system to the rotary dial and from the rotary dial back to a same or different linear motor conveyor system.

In some aspects, the plurality of first gripping devices supported by the rotary dial and the one or more second gripping devices arranged on the linear motor conveyor system have a matching pitch between adjacent gripping devices in an object handoff region.

In some aspects, the first and second gripping devices have an opening that is adjustable to grip objects of varying sizes.

In some aspects, the object handling system comprises a plurality of objects of at least two different sizes at a given time.

In some aspects, the object handling system runs at 600 parts per minute or greater.

In some aspects, the object is a syringe, a cartridge, or a vial.

In some aspects, the object is a vial, and wherein the rotary dial is part of a labelling system, a vision inspection system, or a high-voltage leak detection system.

In some aspects, the rotary dial is in continuous motion and the linear motor conveyor system is asynchronous and allows independent control of the one or more second gripping devices arranged thereon.

In some aspects, the linear motor conveyor system comprises a plurality of track sections including one or more straight track sections and one or more curved track sections, and wherein the rotary dial and the linear motor conveyor system are arranged such that the object handoff occurs at a curved track section.

In accordance with another aspect of the present disclosure, a method of handing off an object between gripping devices is disclosed, comprising: gripping a first portion of the object with a gripping device on a linear motor conveyor system; controlling a rotary dial having a different gripping device arranged thereon, and controlling movement of the gripping device on the linear motor conveyor system, to position the gripping device on the linear motor conveyor system and the gripping device on the rotary dial to be in spatial relationship for object handoff; gripping a second portion of the object with the gripping device of the rotary dial; and releasing the object with the gripping device on the linear motor conveyor system.

In some aspects, the method further comprises: moving the object around the rotary dial; and handing off the object from the gripping device on the rotary dial to a second gripping device on a second linear motor conveyor system.

In some aspects, the method further comprises: moving the object around the rotary dial; recirculating the object on the rotary dial; and controlling a second gripping device on a second linear motor conveyor system to prevent object handoff from the gripping device on the rotary dial.

In some aspects, the linear motor conveyor system comprises a plurality of gripping devices for handing off objects to the rotary dial, and the method further comprises controlling the gripping devices on the linear motor conveyor system to prevent object handoff to the gripping device on the rotary dial during recirculation.

The present disclosure provides a rotatable linear actuator where linear motion of a drive shaft is achieved using a magnet and coil assembly, thus allowing the drive shaft to be rotatable while also being linearly actuated. The use of the magnet and coil assembly to drive the drive shaft provides for a simplified device and compact design as components of the actuator driving the drive shaft in the linear direction do not have to rotate.

As discussed above, there are several applications where it would be beneficial to rotate a linear actuator, and the rotatable linear actuator in accordance with the present disclosure can be scaled up or down and used in any application requiring both linear actuation and rotation of one or more actuated components. The rotatable linear actuator may provide particular benefits when used in applications where an element is being rotated more than 180 degrees, for example, and even further benefits in applications where the element is being rotated 360 degrees more than once, where a wired connection cannot be designed to accommodate the rotation.

Accordingly, although the present disclosure describes the rotatable linear actuator with reference to a particular implementation where the rotatable linear actuator is used in a gripping device as part of a manufacturing/quality control application, it will be appreciated that the rotatable linear actuator can be used in any application requiring both linear actuation and rotation of an actuated component.

Additionally, the present disclosure describes an object handling system and associated method that is configured to transfer an object between two different machines. In one aspect of the present disclosure, the object handling system comprises a rotary dial and a linear motor conveyor system, and is configured to transfer or handoff an object between a gripping device on the linear motor conveyor system and a gripping device on the rotary dial. A control system is configured to control actuation of one of the plurality of first gripping devices and the one or more second gripping devices to grip and to release an object in synchronization with movement of the rotary dial and linear motor conveyor system, to thus enable object handoff between a first gripping device and a second gripping device. A gripping device comprising the rotatable linear actuator disclosed herein is particularly useful for object handoff as a gripping unit of the gripping device can be linearly actuated and rotatable, providing increased flexibility for object handling as well as object transfer. The gripping devices on the rotary dial and the linear motor conveyor system may be the same or different types of gripping devices. The object handling system can be specifically designed to support high speed, high throughput object handoff. Preferably, each of the first and second gripping devices have an opening that is designed to grip objects of varying sizes/diameters, and therefore the object handling system may support multiple object types without retooling or downtime, and may even comprise a plurality of objects of at least two different sizes at a given time. While the present disclosure specifically describes object handoff as occurring between a linear motor conveyor system and a rotary dial, it will also be appreciated that the disclosure is not specifically limited to this configuration and could be used to implement object handoff between two linear motor conveyor systems, or between two rotary dials, or between an arrangement with multiple rotary dials and/or linear motor conveyor systems.

The object handling system can be used for handling a variety of objects, such as vials, syringes, cartridges, etc. In one example implementation, the object is a vial and the rotary dial may form part of a labelling system, a vision inspection system, or a high-voltage leak detection system. The object can be transferred from the linear motor conveyor system to the dial, the object is labelled or inspected while travelling on the dial, and the object is transferred back to the linear motor conveyor system (or to another linear motor conveyor) after the label has been applied or the inspection has been performed. In some applications an object that has been transferred to the rotary dial inspection may need to remain on the rotary dial for reinspection, and embodiments herein also enable control to prevent object handoff between gripping devices in order to allow for recirculation and advanced object handling operations.

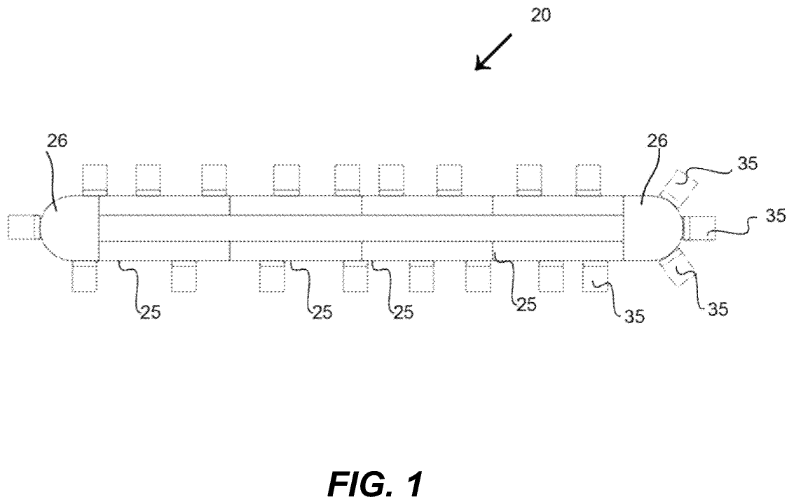

Embodiments are described below, by way of example only, with reference to FIGS. 1-12.

FIG. 1 shows a schematic diagram of an example conveyor system 20. The conveyor system 20 includes one or more track sections 25, 26 defining a track. In FIG. 1, a plurality of straight track sections 25 are provided with two curved sections 26. A plurality of moving elements 35 are provided to the track and move around on the conveyor system 20. In a manufacturing environment, the moving elements 35 are intended to travel between workstations (not shown) and may support a pallet or product (not shown) that is to be operated on automatically by, for example, a robot, while moving or at a workstation or may travel to a workstation or other work area intended for manual operations. Through the operation of the conveyor system 20, various operations are performed to provide for the assembly and/or inspection of a product. In this disclosure, the terms “moving element”, “shuttle”, and “pallet” may sometimes be used interchangeably, depending on the context. As described further herein, at least some moving elements or pallets comprise a gripping device that is used for gripping an object, such as a vial, syringe, cartridge, etc. Accordingly, the moving element with a gripping device can grip an object and travel around the track.

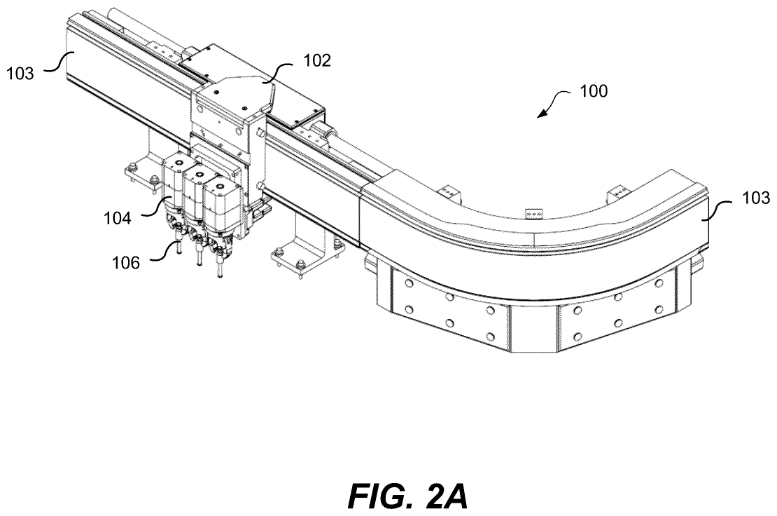

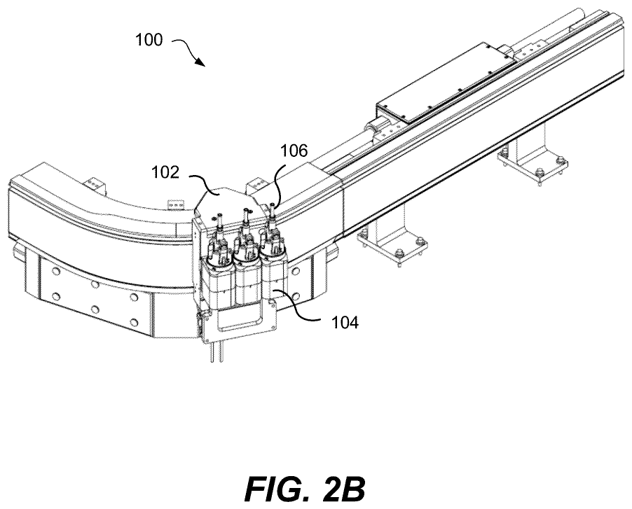

FIGS. 2A and 2B show a representation of a conveying system 100 used in a manufacturing process with a moving element comprising a gripping device 104 using a rotatable linear actuator in accordance with the present disclosure. The gripping device is arranged on the conveying system via a support unit 102. The conveying system 100 may for example be a SuperTrak™ conveying system by ATS™, however it will be appreciated that the rotatable linear actuator may be used as part of other devices (i.e. not just a gripping device), and with other types of applications (e.g. as an end effector on a robotic arm, in pick-and-place applications, for example).

As seen in FIGS. 2A and 2B, the gripping device 104 is mounted on a track 103 of the conveying system 100 via a support unit 102 and may be arranged in different configurations for gripping an object 106, such as facing downward to grip object 106 from above (as in FIG. 2A) or facing upward to grip the object 106 from below (as in FIG. 2B). The conveying system 100 in this example is configured to drive the support unit 102 linearly along a rail of a track 103 to move the gripping device 104 from one position to another. In this manner, the rotatable linear actuator may be used to cause the gripping device 104 to pick up an object at one location, and the gripping device 104 can be driven to another location along the conveying system 100, where the object is dropped off. The support unit 102 may also provide means to move the movement along the track by rollers, or belts to facilitate movement of the unit.

The conveying system 100 may in particular be a linear motor conveyor system having one or more track sections, including straight and/or curved track sections, which may be modular in nature to allow for various shapes and sizes of conveyors and any appropriate number of moving elements thereon. The track sections forming track 103 may be mechanically self-contained and separable from one another so as to be modular in nature. In order to be modular, each track section may house electronic circuitry and/or mechanical parts for powering and controlling the related track section and/or there may be a controller/control system that controls the related track section or the track 103 overall. In some cases the track controller may communicate or interface with track section controllers provided for each of the track sections. The controller(s) may include a processor that executes a program stored on a non-transitory machine-readable medium. The machine readable medium may be a part of the controller or at a remote location or the like.

In a linear motor conveyor system 100, the track 103 may produce a magnetic force for moving the moving element (such as support unit 102 supporting the gripping device 104) along the track 103. The magnetic force can also capture, support or hold the moving element on the track 103. The magnetic force is at least partly generated by the interaction of the magnetic flux created by embedded coils of the track 103 and magnetic elements of the moving element. It will be understood that conveyor systems with different motor drives may be driven in other manners.

The track 103 may be made up of track sections, joined end-to-end, with one or more guide rails of each track section aligned with a guide rail of adjacent track sections. The moving elements may include bearings that are correspondingly shaped in order to run along a corresponding guide rail.

In some embodiments, the track section may produce a magnetic force for moving the moving element along the track 103. The magnetic force can also capture/hold the moving element on the track 102. In some cases, the magnetic force is created by the interaction of the magnetic flux created by coils (not shown) embedded in/under the track section and magnetic elements (not shown) of the moving element. The magnetic force can be thought of as having a motive force component for directing movement of the moving element along a direction of travel on the track 103, and a capturing force component to laterally hold the moving element on the track 103 and in spaced relation to the track surface. In at least some conveyor systems, the motive force and the capturing force can be provided by the same magnetic flux.

Generally speaking, the track sections are mounted on a support structure (not shown) so as to align and abut one another in order to form the track 103. As noted above, each track section may be controlled by a control system or by a track control system that controls a plurality of or all of the track sections.

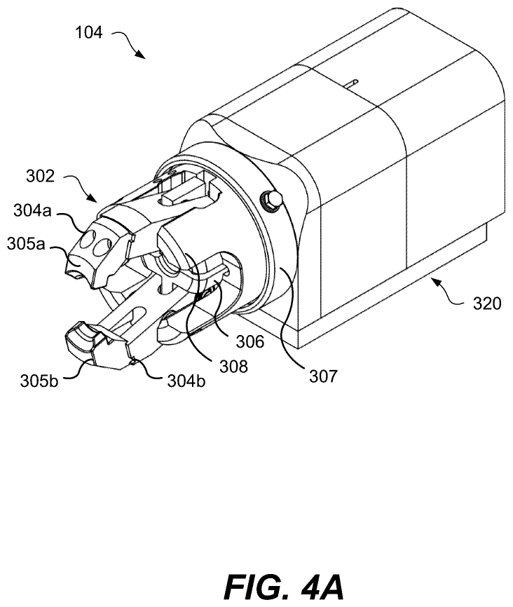

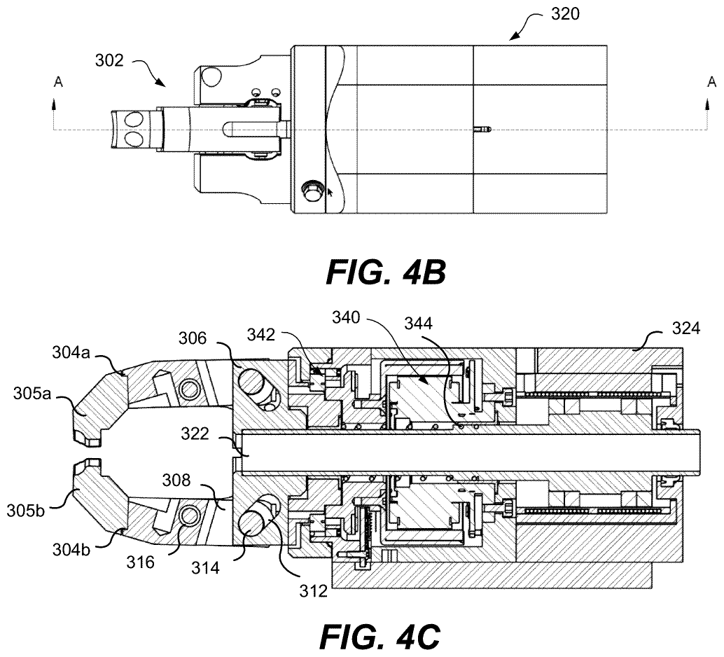

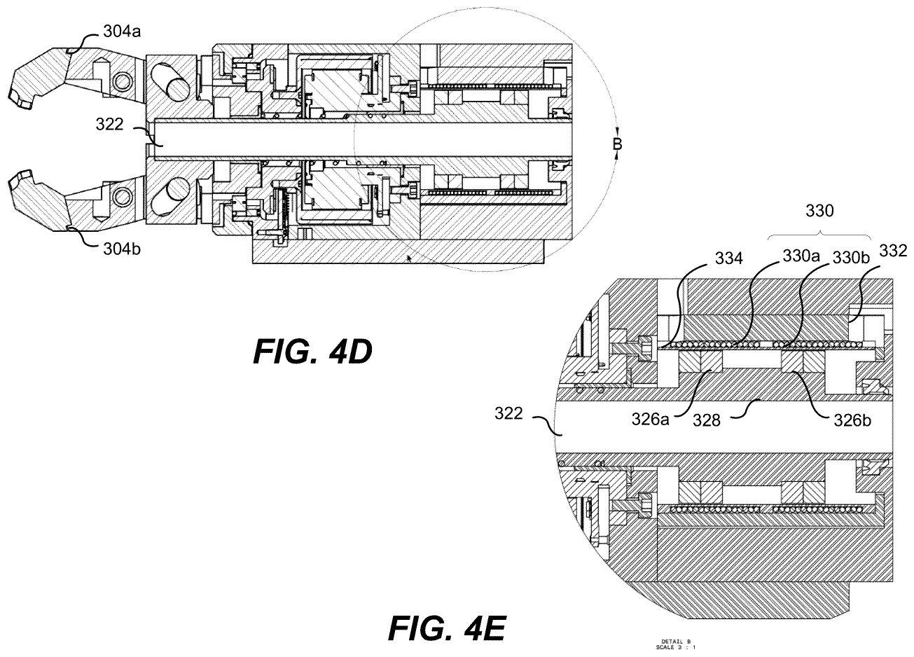

In certain implementations, one or more cameras (not shown) may be arranged at different locations along the conveying system 100 to image the object 106 held by the gripping device 104 for inspection. For example, the camera may be used to inspect a cap of the object, crimping or cracks in the object, and/or the substance inside the object. In some applications, the object may contain a liquid and the camera may be used to inspect for any particulates in the liquid. As would be appreciated, to facilitate inspection of the object, it would be desirable to rotate the object 106 while it is held by the gripping device 104. As described in more detail with reference to FIGS. 4A-E, the rotatable linear actuator in accordance with the present disclosure comprises a drive shaft configured to be linearly actuated along its longitudinal axis and rotatable around its longitudinal axis. In the gripping device 104, the drive shaft is configured to actuate a gripping unit between open and closed positions to grip and release an object, and is also able to be rotatable to support rotational movement of the gripping unit. The drive shaft is thus configured to be rotated and linearly actuated, including being simultaneously rotated and linearly actuated. Accordingly, a gripping device using the rotatable linear actuator in accordance with the present disclosure can grip and rotate objects to facilitate inspection. The rotatable linear actuator design also facilitates hand-off of objects between gripping devices, and a method of transferring an object between two gripping devices is also disclosed.

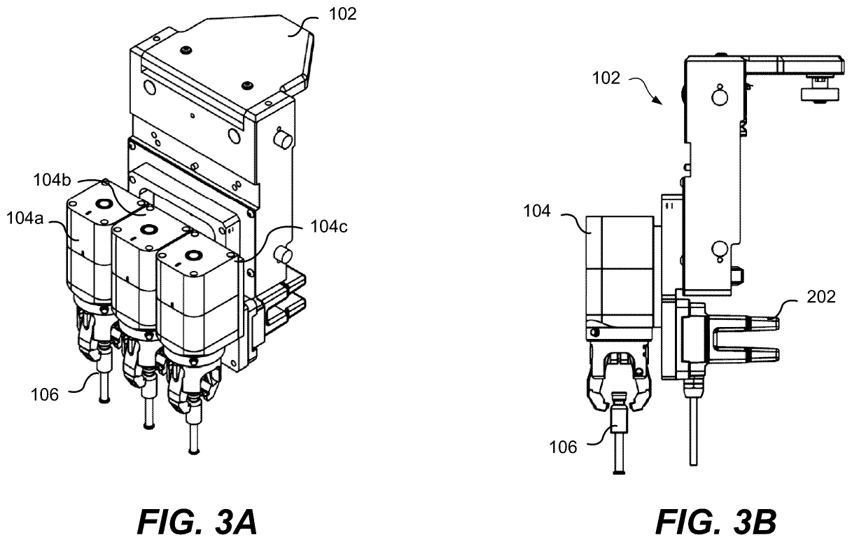

FIGS. 3A and 3B show a representation of the gripping device 104 using the rotatable linear actuator arranged on a support unit 102 for mounting to the conveying system. FIG. 3B also provides an enlarged view of the gripping device 104 holding object 106. FIG. 3A shows multiple gripping devices 104a, 104b, 104c coupled to a common support unit 102.

In this particular implementation, the support unit 102 may provide power to the gripping device 104. In some examples, the support unit 102 may provide inductive power to the gripping device 104, and the support unit comprises inductive power pickup 202, where power is delivered to the gripping devices by inductive power coils along the track to the rear of the support unit 102. The gripping device 104 may comprise or be coupled to a microcontroller (not shown) that is configured to control power to different components of the gripping device. The gripping device 104 and particularly the rotatable linear actuator may also comprise a wireless transceiver configured to receive commands from a central controller allowing communication to one or more gripping devices.

The support unit 102 is one example of how the gripping device 104 may be mounted to a conveying system, however as described with reference to FIGS. 2A and 2B, the rotatable linear actuator may be used in other applications and the use of support unit 102 for mounting gripping device 104 is therefore a non-limiting example.

FIGS. 4A-E show the gripping device 104, comprising a gripping unit 302 and a rotatable linear actuator 320 in accordance with the present disclosure. FIG. 4A is a perspective view of the gripping device 104. FIG. 4B is a top view of the gripping device 104. The rotatable linear actuator 320 is configured to linearly actuate and rotate actuated components of the gripping unit 302. Again, it will be appreciated that the rotatable linear actuator 320 may be used to linearly actuate and rotate various types of actuated components, and therefore the use of gripping unit 302 is non-limiting.

The gripping unit 302 comprises at least one actuated gripper jaw that is configured to be actuated to grab and release an object. While different configurations of gripping units are possible, the gripping unit 302 as shown comprises two actuated gripper jaws 304a and 304b, which comprise hinged gripper fingers 305a and 305b configured to grip the object, although more actuated gripper jaws may be utilized. The gripper jaws 304a and 304b may be pivotally arranged on a gripper housing 308, which is configured to be rotated. Bearings (not seen in FIG. 4A) are used to facilitate rotation of the gripper housing 308, and are covered with a bearing cap 307. Further, the gripper jaws 304a and 304b are coupled to a slotted hub 306 that receives a drive shaft of the rotatable linear actuator 320 and is configured to be linearly actuated. Actuation of the slotted hub 306 by the drive shaft of the rotatable linear actuator 320 causes actuation of the gripper jaws 304a and 304b about the pivot, as described in more detail below, between an open and a closed position. Advantageously, the rotatable linear actuator 320 supports both linear and rotational motion to linearly actuate the slotted hub 306 and to rotate the gripper housing 308.

FIG. 4C is a cross-sectional view of the gripping device taken along the line A-A in FIG. 4B, with the rotatable linear actuator 320 actuated so that the gripping unit 302 is in a closed configuration. FIG. 4D is a cross-sectional view of the gripping device with the rotatable linear actuator 320 actuated so that the gripping unit 302 is in the open configuration taken along the line A-A in FIG. 4B.

Actuation of the gripping unit 302 between the open and closed configurations is achieved by actuation of a drive shaft 322 that is coupled to the slotted hub 306 of the gripping unit 302 at a first end thereof. The drive shaft 322 is configured to be linearly actuated within housing 324 of the rotatable linear actuator 320 to actuate the gripper jaws 304a and 304b of the gripping unit 302 between the open and closed configurations. In the configuration shown in FIGS. 4C and 4D, the slotted hub comprises angled slots 312, and the gripper jaws 304a and 304b are respectively coupled to the slotted hub 306 via rollers 314. The gripper jaws 304a and 304b are pivotally coupled to the gripper housing 308 via pivot pins 316.

Referring to FIG. 4C, the angled slots 312 are configured such that as the drive shaft 322 is translated rearward, the slotted hub 306 is moved rearward and the rollers 314 are pushed forward within the angled slots 312. In this position, the hinged connection comprising the pivot pins 316 cause the gripper jaws 304a and 304b and corresponding gripper fingers 305a and 305b to close. Referring to FIG. 4D, as the drive shaft 322 is translated forwards along its longitudinal axis, the slotted hub 306 is moved forward and rollers 314 slide rearward within the angled slots 312. In this position, the hinged connection comprising the pivot pins 316 cause the gripper jaws 304a and 304b and corresponding gripper fingers 305a and 305b to open. In the open position shown in FIG. 4D, the slotted hub 306 is moved linearly in the axial direction by the drive shaft 322. An amount of axial movement may be set by an angle and length of the angled slots 312. Other shapes of angled slots 312 are also possible, such as an “s” shape, which could transition the actuated component between different states (e.g. corresponding to closed, open, and then closed positions). In a further embodiment, the linearly actuated component (i.e. the slotted hub 306 in this case) may be further actuated in the axial direction by inclusion of a second linear actuator coupled to the drive shaft 322.

While the connection between the gripper jaws 304a and 304b, the slotted hub 306, and the drive shaft 322 provides a particularly compact design, a person skilled in the art will also appreciate that other configurations are possible to cause the gripper jaws to open and close, and that such designs may be implemented without departing from the scope of this disclosure. Further, various actuated components could be used instead of gripping unit 302, and therefore the particular connection with which the drive shaft 322 causes actuation of the linearly actuated component can vary.

Linear movement of the drive shaft 322 within the actuator body 324 is advantageously achieved using a magnet and coil assembly. As best seen in FIG. 4E, which shows a detailed view of the area B circled in FIG. 4D, one or more permanent magnets that are magnetized in a radial direction are coupled to the drive shaft 322. In this implementation, there are two sets of permanent magnets 326a and 326b, each set having opposite polarity orientation. There are two magnets shown in each set of the permanent magnets 326a and 326b, simply to double the force in this specific application. The permanent magnets 326a and 326b are coupled to a second end of the drive shaft (i.e. opposite from the end that is coupled to the slotted hub 306), and there is a magnetically-permeable material 328 disposed between the drive shaft 322 and the permanent magnets 326a and 326b.

One or more electric coils 330 are disposed within the actuator body around the one or more permanent magnets. The electric coils 330 are configured to receive an electric current that interacts with a magnetic field of the one or more permanent magnets to generate an axial force to linearly actuate the drive shaft 322. In this example, there are two sets of permanent magnets 326a and 326b, and there are two corresponding electric coils 330a and 330b disposed around the permanent magnets. The two electric coils 330a and 330b are wound in opposite directions since the polarity of the magnets 326a and 326b are opposite each other. Alternatively, instead of having two electric coils 330a and 330b, a single continuous electric coil 330 may be used, wound clockwise around one set of permanent magnets and counter-clockwise around the other set of permanent magnets. The electric coil 330 or electric coils 330a and 330b are configured so that they extend along an axial direction in a range of movement of the magnets 326a and 326b on the drive shaft 322.

The electric coils 330a and 330b are disposed within the actuator body 324 of the rotatable linear actuator 320, and more specifically within a magnetically-permeable coil housing 332. The electric coils 330a and 330b may be wrapped around a plastic bobbin 334, which holds the electric coils 330a and 330b in place. A spring 344 (see FIG. 4C) may be used to help provide a restorative force to the drive shaft 322.

Note that in an alternative configuration, one magnet or set of magnets having the same polarity could be used with one electric coil. The space where the second magnet is shown in FIG. 4E could be filled with steel/iron to keep the air gap in the flux circuit small. However, generally speaking, the use of a second magnet (or set of magnets) and coil yields more force for a given volume of actuator.

Referring again to FIG. 4C, in this implementation the rotatable linear actuator 320 comprises an electric motor 340 configured to cause rotation of the gripper housing 308 and associated gripper jaws 304a and 304b. In this configuration the motor stator is radially inside of the rotor. One or more bearings 342 facilitate rotation of the gripper housing 308. Rotation of the gripper housing 308 rotates the gripper jaws 304a and 304b, and causes corresponding rotation of the slotted hub 306 and drive shaft 322. Due to the magnet and coil assembly described above, the drive shaft 322 can be rotatable about its axis while being linearly actuated, and there is no need for a corresponding rotation of other linear actuator components such as the electric coils 330, thus providing a simplified and compact design of the rotatable linear actuator 320.

Various types of encoders or sensors could be used to provide positional feedback on the drive shaft 322, magnets 326, motor 340, etc. As one example, a laser or optical sensor may be used at the end of the drive shaft 322 to determine its position.

While FIGS. 4C-E show a particular configuration of the magnet and coil assembly with respect to the drive shaft 322, it will be appreciated that design variations are possible and within the scope of this disclosure. As one example, instead of the magnets 326a and 326b being disposed at a distal or second end of the drive shaft 322 that is away from the gripping unit 302, the magnets 326 and the electric coils 330 could be disposed at a proximal or first end of the drive shaft 322 that is closer to the gripping unit 302.

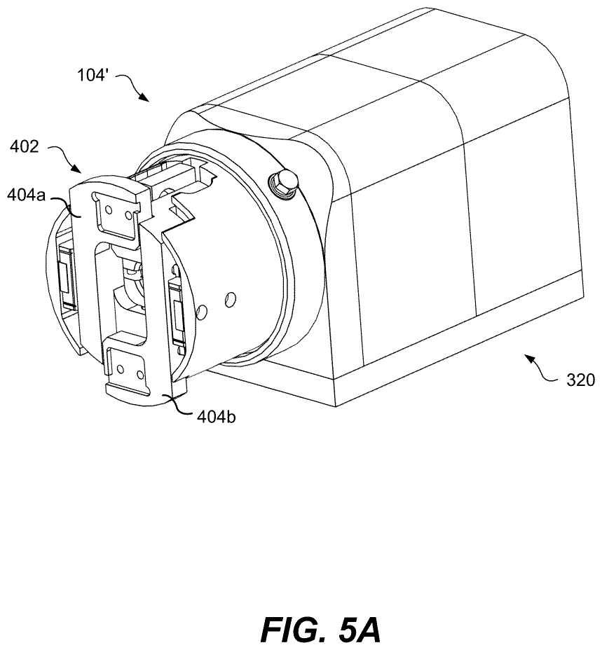

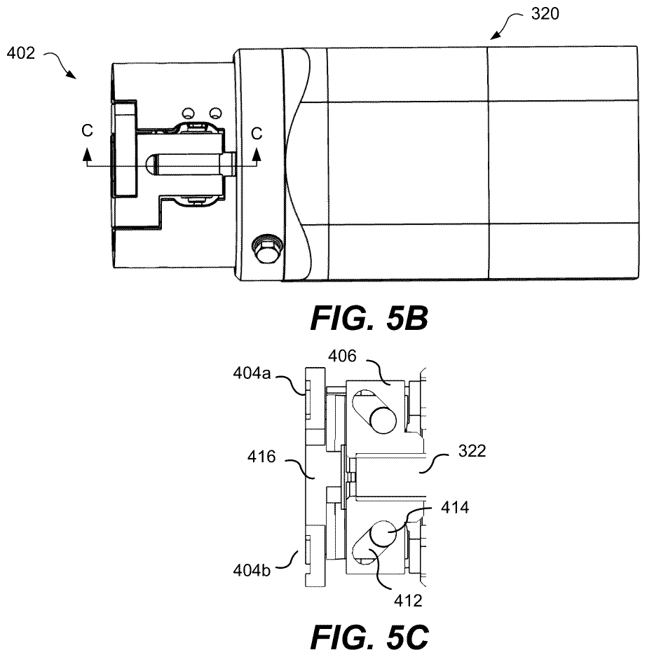

FIGS. 5A-5C show an example of an alternative gripping device 104′ comprising a different gripping unit 402 but the same rotatable linear actuator 320 in accordance with the present disclosure. FIG. 5A is a perspective view of the gripping device 104′. FIG. 5B is a top view of the gripping device 104′. FIG. 5C is a sectional view of the gripping unit 402 taken along line C-C in FIG. 5B.

As described above, different components, including different gripping units, may be coupled to and actuated by the rotatable linear actuator 320. In the alternative gripping device 104′, instead of gripper jaws 304a and 304b that are pivotally coupled to the gripper housing 308, gripping unit 402 comprises gripper jaws 404a and 404b that are actuated along respective linear rails in a direction towards and away from each other. With two gripper jaws 402a and 402b, the gripper jaws are actuated in opposite directions parallel to each other. However, it would also be appreciated that a different number of gripper jaws may be present, such as four gripper jaws. The linear rails are arranged along a gripping surface of the gripping unit 402 (i.e. perpendicular to the longitudinal axis of the drive shaft 322).

As seen in FIG. 5C, the gripping unit 402 may similarly comprise a slotted hub 406 that is coupled to and linearly actuated by the drive shaft 322 of the rotatable linear actuator 320. The slotted hub 406 comprises angled slots 412, and actuation of the gripping unit 402 between the open and closed configurations is achieved by actuation of the drive shaft 322 that is coupled to the slotted hub 406. In the configuration of the gripping unit 402 shown in FIG. 5C, the gripper jaws 404a and 404b are respectively coupled to the slotted hub 406 via rollers 414, and the gripper jaws 404a and 404b are linearly translatable along a respective linear rail 416 coupled to the slotted hub 406.

More specifically, referring to FIG. 5C, the angled slots 412 are configured such that as the drive shaft 322 is translated forward, the slotted hub 406 is moved forward and the rollers 414 are pushed rearward within the angled slots 412. The gripper jaws 404a and 404b are respectively coupled to the slotted hub 406 via rollers 414 at distal ends thereof. That is, the gripper jaw 404a in FIG. 5C is coupled to the angled slot labelled 412 in FIG. 5C, and the gripper jaw 404b is coupled to the other angled slot. FIG. 5C shows the gripper jaws 404a and 404b in an open position. When the drive shaft is actuated rearward, the rollers 414 within the angled slots 412 are pushed forward, which pulls the respective gripper jaws 404a and 404b towards each other along their respective linear rails 416 and transitions the gripper device 402 to a closed position.

An amount of movement of the gripper jaws 404a and 404b may be set by an angle and length of the angled slots 412. Again, other shapes of angled slots 412 are also possible. While the connection between the gripper jaws 404a and 404b, the slotted hub 406, and the drive shaft 322 provides a particularly compact design, a person skilled in the art will also appreciate that other configurations are possible to cause the gripper jaws to open and close, and that such designs may be implemented without departing from the scope of this disclosure.

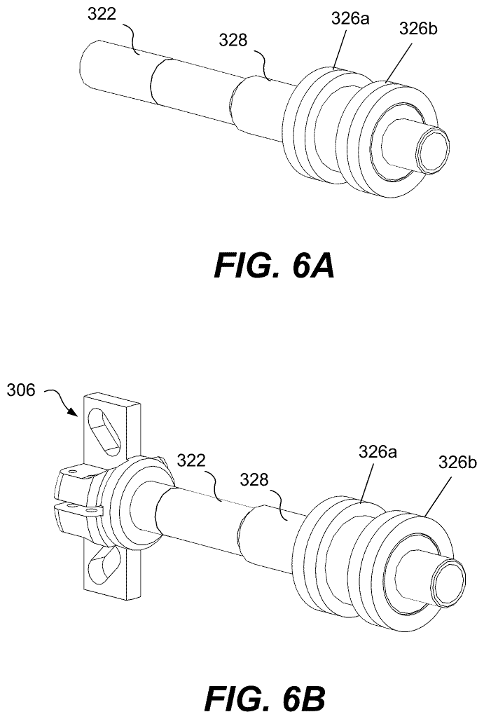

FIG. 6A shows the drive shaft 322 and magnets 326a and 326b of the rotatable linear actuator 320, with the magnetically-permeable material 328 disposed there-between. FIG. 6B shows the drive shaft and magnets of the rotatable linear actuator, with the drive shaft 322 coupled to the slotted hub 306 of the gripping unit in FIGS. 4A-E.

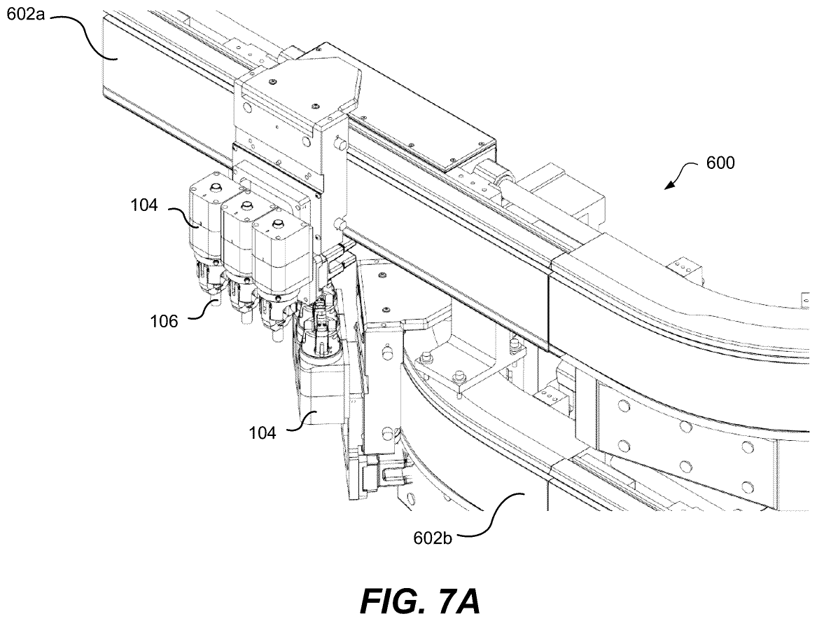

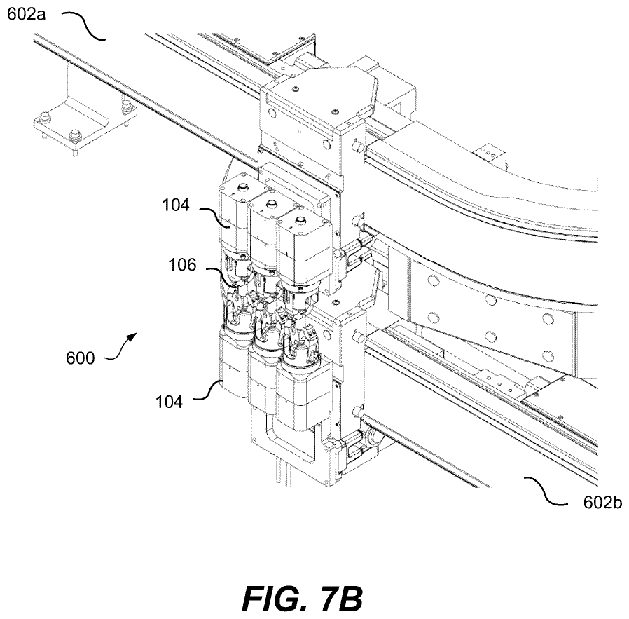

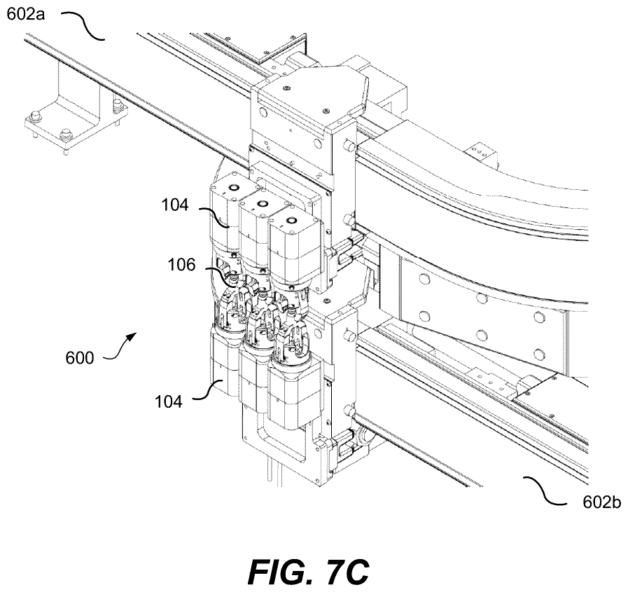

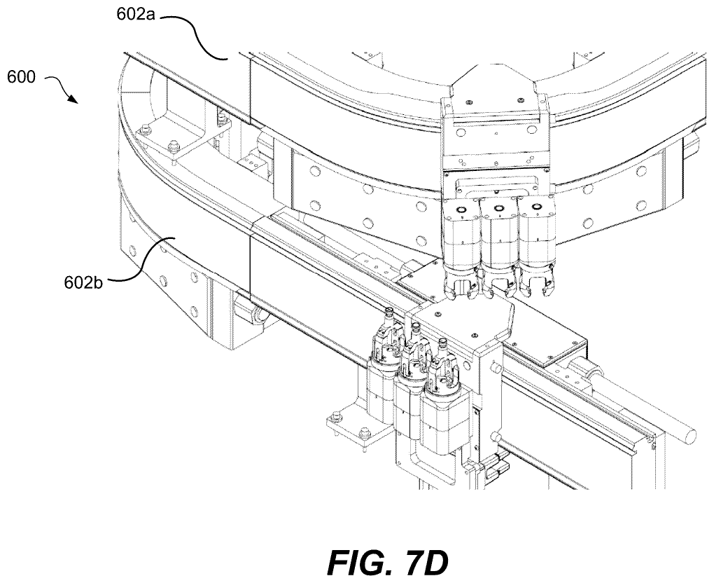

FIGS. 7A-D show a representation of transferring an object between gripping devices using the rotatable linear actuator in accordance with the present disclosure on a conveying system 600. One application of being able to rotate and linearly actuate an actuated component using the rotatable linear actuator as described is the capability of performing advanced operations. In this example, the conveying system 600 may substantially correspond to the conveying system 100 shown in FIGS. 2A and 2B, and comprises a top track 602a and a bottom track 602b, each having a gripping device 104 disposed thereon (in this case there are three gripping devices on the top and bottom tracks).

There may be situations where it is desirable to hand-off objects from one gripping device 104 on one track of the conveying system 600 to another gripping device 104 on another track of the conveying system 600. For example, as described with reference to FIGS. 2A and 2B there may be one or more cameras arranged along the conveying system for imaging the object to inspect for defects. When the object is being held from above there is a clear image of the lower portion of the object but it may be difficult to image the top portion/cap of the object. On the other hand, when the object is being held from below there is a clear image of the top portion and cap of the object but it may be difficult to image the bottom portion of the object. In accordance with the present disclosure, a gripping device 104 on one track of the conveying system 600 can be operated to hand-off the object 106 to the gripping device 104 on another track of the conveying system as a result of the rotatable linear actuator disclosed herein. Specifically, FIGS. 7A-D show the object 106 being transferred from the gripping device 104 on the top track 602a to the gripping device 104 on the bottom track 602b.

FIG. 7A shows the object 106 being held by the gripping device 104 on the top track 602a. The gripping device 104 on the top track 602a and the gripping device 104 on the bottom track 602b are being driven towards each other. As the gripping devices approach each other they are rotated to ensure each gripper is in a desired orientation to facilitate the hand-off. Rotating the grippers to the desired orientation may also be particularly important for non-symmetric objects being held by the grippers.

FIG. 7B shows the object 106 being held by gripping device 104 of the top track 602a while the gripping device 104 of the bottom track 602b is positioned directly underneath. The gripping devices move towards each other with constant and equal velocity, and have been rotated to a desired orientation. When the gripping device 104 on the top track 602a is directly above the gripping device 104 on the bottom track 602b, the gripping device 104 on the bottom track 602b is actuated to grip the object 106. Once the gripping device 104 on the bottom track 602b has gripped the object 106, the gripping device 104 on the top track 602a is actuated to release the object 106. FIG. 7C shows the gripping device 104 on the bottom track 602b holding the object 106 and the gripping device 104 on the top track 602a having released the object 106. FIG. 7D shows the object 106 being held by the gripping device 104 on the bottom track 602b moving away from the gripping device 104 on the top track 602a.

In accordance with the handoff of the object 106 between gripping devices 104, the gripping device 104 are actuated at certain times for grip/release the object to facilitate the handoff. As also described, the gripping device 104 may be rotated before, during, and/or after the handoff. Accordingly, the rotatable linear actuator disclosed herein which permits linear actuation of the drive shaft while being rotated is particularly suited for performing the gripper-to-gripper handoff of an object between gripping devices.

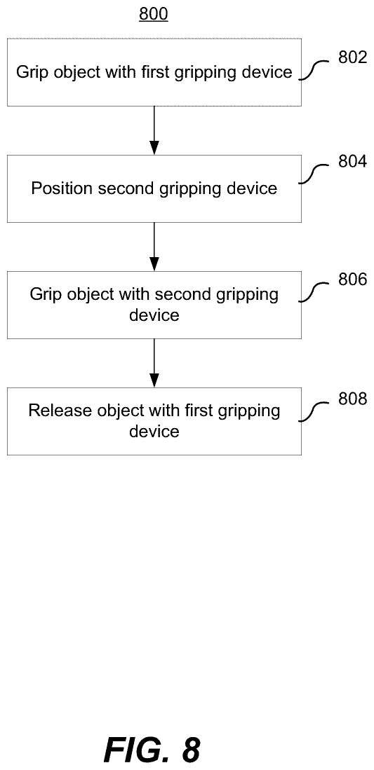

FIG. 8 shows a method 800 of transferring an object between gripping devices using the rotatable linear actuator in accordance with the present disclosure. The method 800 may for example be performed on the conveying system 600 where one gripping device 104 is arranged on a first track and a second gripping device 104 is arranged on a second track.

The method 800 comprises gripping a first portion of a object with a first gripping device (802). A second gripping device is positioned at a second portion of the object (804). For example, positioning the gripping device at the second portion of the object may comprise moving the first gripping device and the second gripping device towards each other at a constant speed. Further, positioning the second gripping device at the second portion of the object may comprise rotating at least one of the first and second gripping devices to a predetermined orientation.

The gripping unit of the second gripping device is actuated to grip the second portion of the object (806), and the gripping unit of the first gripping device is actuated to release the first portion of the object (808). When one or both of the first and second gripping devices are being actuated to grip/release the object, they may also be rotated. The operation of the object transferring procedure can occur by a controller operating the movement and actuation of the associated grippers. Sensors may be provided for determining location and operation state of the gripper process. Alternatively the actuation of the gripper may be performed based upon timed or position based triggers.

It will also be appreciated that there may be various configurations of conveying systems and other equipment/machines designed for different object handling applications, such as part of a manufacturing and/or quality control environment. In one embodiment, a linear motor conveyor system, equipped with one or more moving elements comprising the gripping device disclosed herein operating thereon, may be used for handing off on an object between the linear motor conveyor system and a rotary dial.

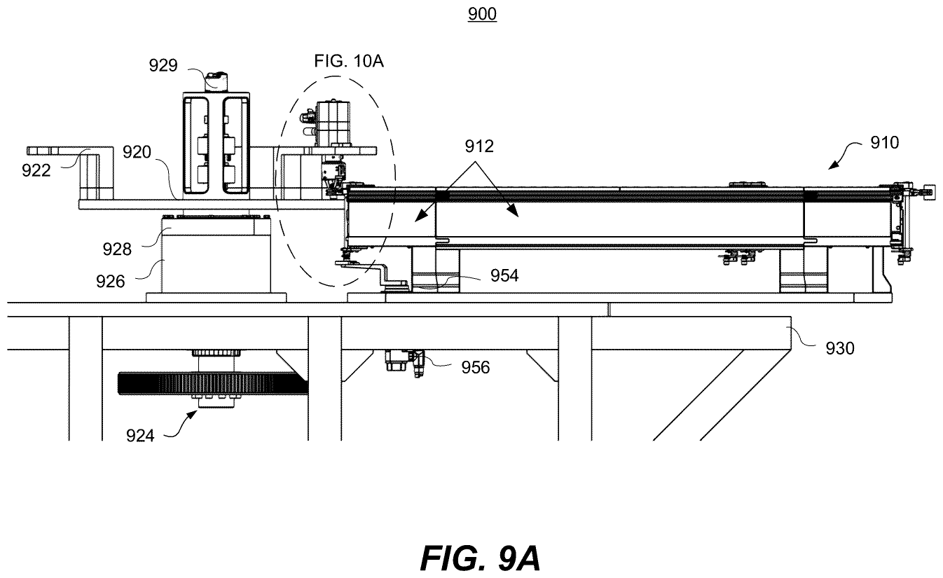

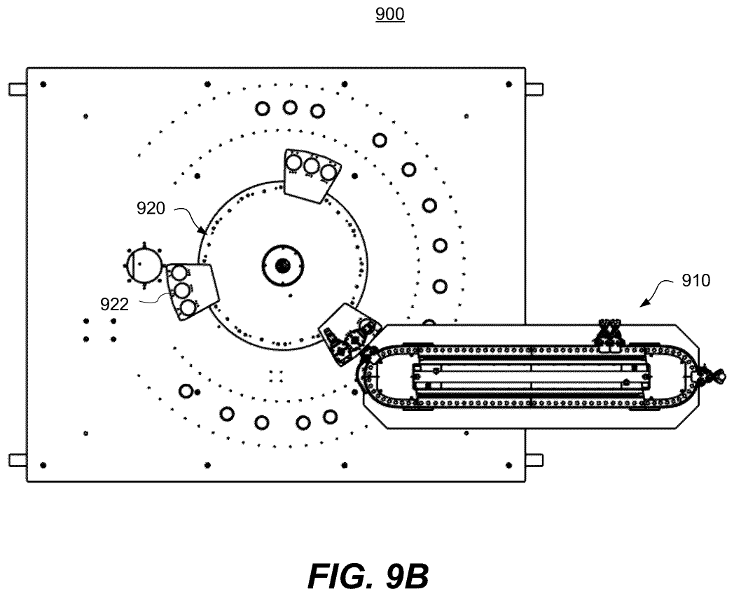

For example, FIGS. 9A and 9B show a side and top view of an object handling system 900 in accordance with embodiments of the present disclosure comprising a linear motor conveyor system 910 and a rotary dial 920. The linear motor conveyor system 910 and rotary dial 920 are arranged on a surface 930 (typically a flat support surface) such as a bench or table top in spaced relation to each other in order to enable object handoff there-between. The object handling system can implement the method 800 of transferring an object between gripping devices, where the object handoff may be between gripping devices on the linear motor conveyor system 910 and the rotary dial 920 instead of being between gripping devices on two separate tracks of a linear motor conveyor system. The object handoff may in particular occur at a curved track section of the linear motor conveyor system, although it may also occur at a straight track section instead.

The linear motor conveyor system may in some configurations have a star wheel arranged at the curved track sections, which comprises radial spokes for engaging a moving element, as for example described in U.S. Pat. Nos. 11,738,952B2 and 12,344,483B2 to ATS Corporation, the entire contents of which are hereby incorporated by reference herein. The star wheel may be driven by a rotary motor, and as the moving element moves from a straight section, driven by, for example, a linear motor, to a curved section, the moving element is configured to engage with the star wheel via, for example, a spoke. The star wheel rotates, thereby moving the shuttle along the circumference of the curved track section. Accordingly, the rotary drive and star wheel are configured to work with the curved track section. In some cases, for a linear motor driven conveyor system, the magnetic force from the moving element can still be used to hold the moving element against the track, acting against the centripetal force and acceleration around the curve.

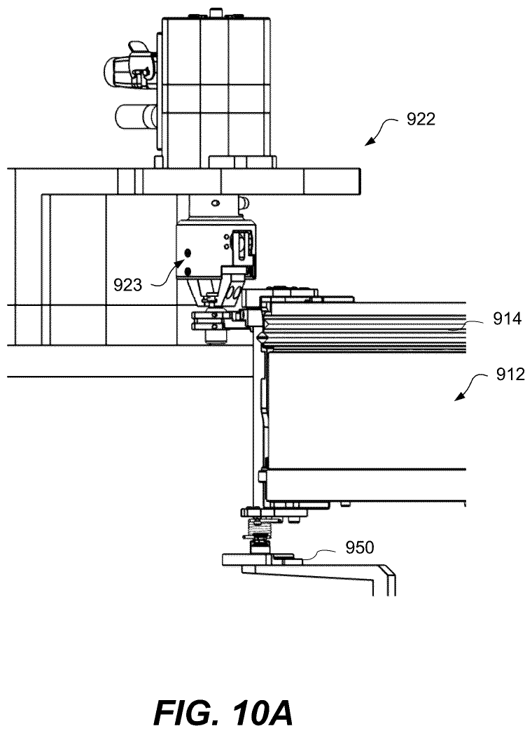

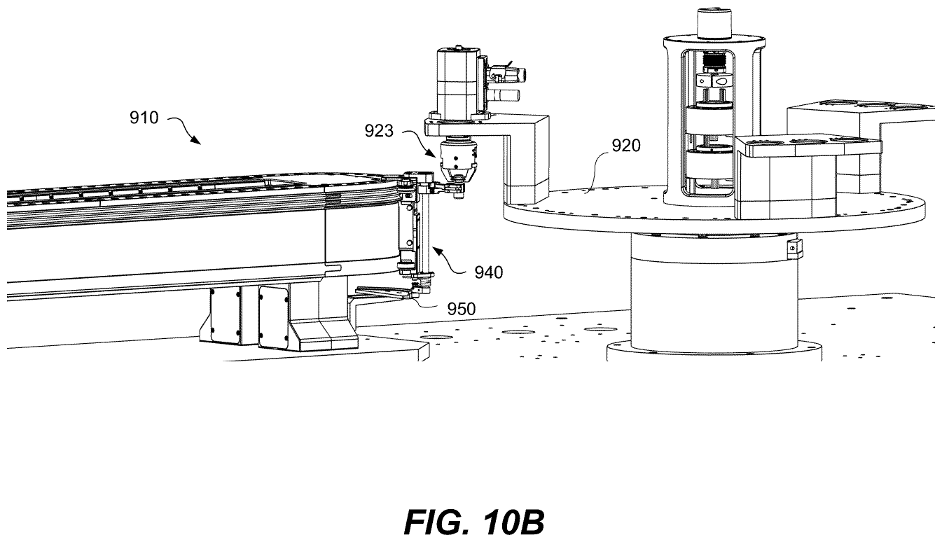

The rotary dial 920 defines a periphery with a plurality of first gripping devices supported by the dial at circumferentially spaced locations about the periphery. As best seen in FIG. 9B, there may be a plurality of gripping supports/mounts 922, each holding one more gripping devices (as more clearly shown in FIGS. 10A/B) that are circumferentially spaced around the periphery. In a particular embodiment, the first gripping devices may correspond to the gripping devices 104 or 104′ comprising a rotatable linear actuator as described above. The rotary dial 920 may be rotatably driven by a rotary motor 924, which may be arranged below the support surface as shown in FIG. 9A, and may for example comprise a pulley and dial shaft arrangement. A housing 926 may be provided to enclose bearings of the rotary motor, and an encoder cover 928 may be provided that houses an encoder for measuring a position of the rotary dial 920 and the gripping supports 922. A further encoder 929 may also be provided at the top of the rotary dial.

In certain implementations, one or more cameras (not shown) may be arranged at different locations around the rotary dial 120 to image an object 102 held by the gripping device for inspection. For example, the camera may be used to inspect a cap of the object, crimping or cracks in the object, and/or the substance inside the object. In some applications, the object may contain a liquid and the camera may be used to inspect for any particulates in the liquid. For example, the object may be a cylindrical object such as a syringe, a cartridge, or a vial. In certain implementations, the rotary dial may be part of a labelling system, a vision inspection system, or a high-voltage leak detection system.

The linear motor conveyor system 910 comprises one or more second gripping devices arranged thereon. The second gripping devices on the linear motor conveyor system may be the same type or a different type of gripping device as the first gripping devices on the rotary dial. The linear motor conveyor system 910 may correspond to the conveyor system 100 as previously described, i.e. with modular track sections and one or more moving elements operating thereon. The one or more moving elements may support the one or more second gripping devices, such that the gripping devices are moveable around the track of the linear motor conveyor system 910 and a position of the moving elements is controllable by controlling the magnetic force.

In particular, a gripping device may be mounted on a moving element of the linear motor conveying system 110 via a support, and may be arranged in different configurations for gripping an object. A gripping device may grip an object from above, below, from behind, etc. The linear motor conveying system 910 is configured to drive a support unit of the gripping device linearly along a rail 914 (see FIG. 10A) of the track sections 912 to move the gripping device from one position to another. In this manner, the gripping device can pick up an object at one location and be driven to another location along the linear motor conveying system to drop off and/or hand off the object. The support unit that supports the gripping device thereon may also provide means to facilitate movement along the track by bearings/wheels. In some embodiments, the support unit may provide power to the gripping device. In some embodiments, the support unit may provide inductive power to the gripping device, and the support unit comprises inductive power pickup, where power is delivered to the gripping devices by inductive power coils along the track to the rear of the support unit. The gripping device may comprise or be coupled to a microcontroller (not shown) that is configured to control power to different components of the gripping device.

A control system (not shown) is configured to control actuation of the plurality of first gripping devices and the one or more second gripping devices to grip and to release an object in synchronization with movement of the rotary dial and the linear motor conveyor system. The control system to control actuation of the gripping device may comprise a plurality of controllers (e.g. one or more controllers that control actuation of the first gripping devices, and one or more controllers that control actuation of the second gripping devices) that are synchronized and/or communicatively coupled. Accordingly, the control system enables and controls object handoff between a first gripping device of the rotary dial and a second gripping device of the linear motor conveyor system (where the object handoff between gripping devices may occur in either direction). Controlling the actuation of the gripping devices may comprise controlling movement/position of the gripping devices on the linear motor conveyor system and controlling rotation of the rotary dial. Alternatively, the control system to control actuation of the gripping devices may be the same or different than a control system that controls rotation of the rotary dial and a control system that controls movement of moving elements on the linear motor conveyor system.

While the object handling system 900 is shown and described as comprising a rotary dial 920 and a linear motor conveyor system 910, it will also be appreciated that various configurations may be implemented for different applications. The object handling system (which may comprise one or more rotary dials, one or more linear motor conveyor systems, etc. to enable gripper-to-gripper handoff between two rotary dials, between two linear motor conveyors, or between a rotary dial and a linear motor conveyor) may have a layout that allows for the creation of gaps and the recirculation of parts without the need for additional mechanisms or dedicated return paths. Accordingly, object handoff could be from dial to dial, dial to linear motor conveyor, one linear motor conveyor to a second linear motor conveyor, or linear motor conveyor to dial, as long as one of the two machines is asynchronous. Having at least one of the two machines that carry gripping devices as a programable machine that enables a programmed trajectory/motion of at least one gripping device, where the programable machine is communication with the control system, can in particular allow for recirculating parts and omissions of object handing off, thus enabling advanced control and operations.

A pitch or distance between adjacent gripping devices on the rotary dial 920 and adjacent gripping devices on the linear motor conveyor system 910 in the object handoff region may be set equal to each other (i.e. to match) to facilitate the object handoff. Shuttles operating on the linear motor conveyor system typically run independently and in an asynchronous way. Before the shuttles enter the handing off zone, they may operate with a narrow pitch, and when one of the shuttles starts to enter the object handoff region and where the gripping device is actuatable, the programed motion of this shuttle is synchronized with the corresponding gripping device on the dial in the handing off region. In some embodiments, an object may be transferred from the linear motor conveyor system 910 to the rotary dial 920 and from the rotary dial 920 back to the linear motor conveyor system 910. In some embodiments, an object may be transferred from the linear motor conveyor system 110 to the rotary dial 120 and from the rotary dial 120 to a second linear motor conveyor system. For example, the object may be a cylindrical object such as a syringe, a cartridge, or a vial. In a particular embodiment, the object is a vial, and the rotary dial is part of a labelling system, a vision inspection system, or a high-voltage leak detection system. The object handling system may run at high speeds, such as a throughput of 600 parts per minute or greater.

The first and second gripping devices may be the same or different types of gripping devices. However, both the first and second gripping devices should have an opening that is designed and/or is adjustable to grip objects of varying sizes, and in some embodiments the object handling system comprises a plurality of objects of at least two different sizes at a given time.

In a particular embodiment of the present disclosure, the gripping devices arranged on the rotary dial 920 comprise the gripping device as disclosed above, i.e. with a rotatable linear actuator coupled to a gripping unit that is configured to be rotated and to be actuated between open and closed positions by the drive shaft to grip the object, such as the gripping device 104 or 104′.

FIGS. 10A and 10B show views from two different angles of an object handoff within the object handling system. The view as shown in FIG. 10A is an enlarged view of the area as indicated in FIG. 9A, as seen from the front. The view as shown in FIG. 10B shows object handoff from the rear. As seen in FIGS. 10A/B, the object handoff occurs at a position where the periphery of the rotary dial 920, and specifically a corresponding gripping support 922 as it is rotated, is near the track section 912, which is preferably at a curved track section.

As described above the gripping support 922 on the rotary dial holds/supports one or more first gripping devices 923, which are shown in FIGS. 10A/10B as angled/spindle style grippers comprising two or more angled gripper jaws for gripping an object. The gripping device 923 may be a parallel gripping device with at least two linearly actuatable gripper fingers for gripping the object, or the gripping device may be a pivotable gripping device with at least two pivotably actuatable gripper fingers for gripping the object. Accordingly, the gripper jaws may be pivotably actuatable about a pivot point or they may be linearly actuatable to move between open and closed positions for gripping and releasing the object. Other types/configurations of gripping devices implemented on the rotary dial 920 are also possible, such as a gripping device comprising a suction or vacuum unit, as well as various other styles of gripping devices. Furthermore, the skilled person would also readily appreciate that the angled/spindle style grippers can be replaced with the gripping device 104 or 104′ comprising the rotatable linear actuator as described herein, which would be advantageous in order to enable rotation of the object held by the gripping device as it travels on the rotary dial 920. Such capability to rotate the object may be particularly desirable in applications such as object labelling, quality control/inspection, etc.

The first gripping devices may be arranged to grip the object from above, below, or from both above and below the object. One or more of the first gripping devices could also be used as a temporary holder for timing purposes (e.g. one of the first gripping devices grips the object from below, and waits for another first gripping device to pass by and grip the object from above to handoff the object there-between).

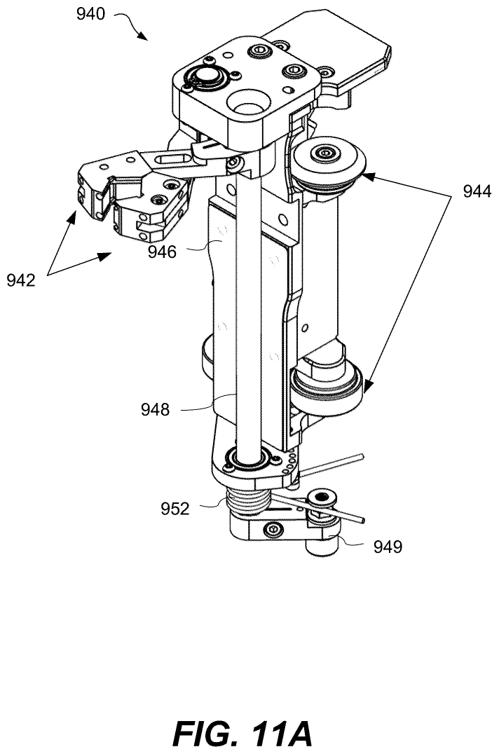

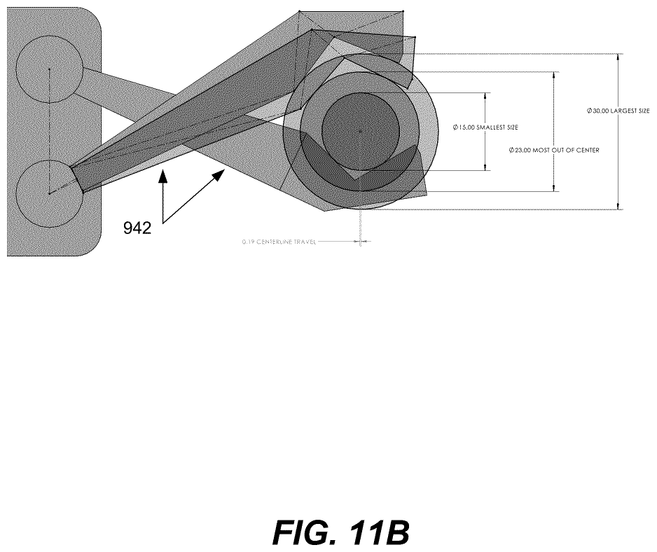

The linear motor conveyor system comprises one or more second gripping devices operating thereon. The second gripping devices may be arranged via a support on a shuttle that comprises wheels or bearings for engaging with a corresponding rail 914 of a track 912 on the linear motor conveyor system 910. The second gripping devices may be the same as the first gripping devices, and may for example comprise the gripping device 104 or 104′ comprising the rotatable linear actuator as described herein. Alternatively, the second gripping devices may comprise different types of gripping devices. An exemplary second gripping device 940 is shown in FIGS. 10A/B, which holds the object in front of the gripping device 940 for facilitating handoff. FIG. 11A shows an isometric view of the gripping device 940 installed on the linear motor conveyor system, however it will also be appreciated that alternative types of gripping devices could also be used such as those described above, with alternative modifications to facilitate operation on a track of a linear motor conveyor system.

As seen in FIG. 11A, the gripping device 940 comprises at least two pivotable gripper fingers 942 for gripping the object. The pivotable gripper fingers 942 are particularly well-suited for gripping different sizes of objects (i.e. different diameters in the case of cylindrical objects). FIG. 11B shows a detailed view of the gripper fingers 942 of the gripping device of FIG. 11A holding different object sizes. High speed hand-offs between two gripping devices requires a low inertia and low friction mechanism. It is also desirable to be able to handle objects of different diameters having a same offset or radial distance along the same centerline. Maintaining the same offset or radial distance along the same centerline allows for much simpler change-overs between part sizes. A typical angular gripper has low inertia and friction, but the centerline of the part may change more than tolerable by the matching mechanism as the part size changes. On the other hand, a parallel style gripper (i.e. with griper fingers that move linearly) will hold the centerline, but requires linear guides resulting in more moving mass. The gripping device 940 shown in FIGS. 11A/B is a pivotable gripping device with a unique scissor type finger arrangement. This arrangement provides the benefits of an angular gripper while providing near constant center position. FIG. 5B shows a geometry of the gripper fingers 942 holding different object sizes, where both the 15 mm and 30 mm diameter objects are on the perfect center position, while the 23 mm object is off but within tolerance by the mating mechanism. An error of this size will not impact the ability to transfer the part. All dimensions shown in FIG. 11B are provided for the sake of example only and are non-limiting, and it will be appreciated that different gripper finger geometry can be used for holding other sizes of objects.

Instead of pivotable gripper fingers 142, linearly actuatable gripper fingers may be used (e.g. that are actuated along a linear rail), subject to the considerations described above. Further, the gripping device 940 also comprises a plurality of wheels 944 for travelling along the track of the linear motor conveyor system 910, and a permanent magnet 946 for interacting with the magnetic flux produced by the track to enable motion of the gripping device 940 along the track.

The gripper fingers 942 of the gripping device 940 are actuated via a cam 950 arranged at a position of the linear motor conveyor system for interacting with the gripping devices (see FIGS. 10A/B). The cam 950 may be stationary and as the gripping device 940 travels along the track, a cam follower 949 (e.g. a bracket) interacts with the cam 950 while the gripping device 940 moves past. The cam 950 may be shaped so that a force applied to the cam follower 949 causes a controlled opening of the gripper fingers. The gripping device 940 comprises a drive shaft 948 coupled to the cam follower 949, which is actuated to effect actuation of the gripper fingers 942. A spring 952 may be coupled to the drive shaft 948 to provide restoring force and to provide a clamping force to the object, thus preventing unwanted rotation of the drive shaft 950.

The cam 950 may be adjusted radially for different sizes of objects (i.e. to change an amount to which the gripper fingers are actuated to open). A motor 956 coupled to a gearbox 954 (see FIG. 9A) may be used to adjust the cam arrangement. Advantageously, the gripper fingers can be designed to accommodate a range of different sized objects without requiring any manual adjustments or retooling, as the degree to which the gripper fingers open can be controlled by the cam 950. Accordingly, the control system in this embodiment controls actuation of the gripping device 940 by controlling movement of the gripping device 940 along the track to interact with the cam 950. The linear motion conveyor can be thought of as a linear servo motor which gets some curvature in places. These systems have some inherent following error, especially when interacting with the cam to open the gripper. However controlling the programmed trajectory can maintain sufficient synchronization to not drop or crash the object during hand-off, and also enables programmed motion to allow for omissions and recirculation.

In some embodiments, the cam 950 may also be linearly actuatable to move into or out of a position for interacting with the cam follower 949. That is, there may be some situations where a linearly moving element with a gripping device is travelling along the track but handoff is not desired. The cam 950 may be moved downwards so that as the moving element passes the cam follower does not interact with the cam 950, which may for example be one mechanism of preventing object handoff during object recirculation, as described further below.

While the above specifically describes the cam configuration for actuating the gripping devices with reference to the linear motor conveyor system, it will be appreciated that a cam configuration may similarly be implemented on the rotary dial 920.

Accordingly, handing off an object between gripping devices in this exemplary object handling system comprising gripping devices on a rotary dial and a linear motor conveyor system can be performed. The method may be performed by the object handling system 100 as described herein, and may be controlled by one or more controllers that control actuation of the gripping devices on the rotary dial and the linear motor conveyor system, which may include rotation of the rotary dial and movement of the gripping devices on the linear motor conveyor system to control handoff and transferring of an object there-between. In one aspect, a method of transferring an object between gripping devices may comprise: gripping a first portion of the object with a gripping device on a linear motor conveyor system; controlling a rotary dial having a different gripping device arranged thereon, and controlling movement of the gripping device on the linear motor conveyor system, to position the gripping device on the linear motor conveyor system and the gripping device on the rotary dial to be in spatial relationship for object handoff; gripping a second portion of the object with the gripping device of the rotary dial; and releasing the object with the gripping device on the linear motor conveyor system.

In some implementations the method may further comprise moving the object around the rotary dial (e.g. to facilitate inspection, quality control, and/or labelling), and handing off the object from the gripping device on the rotary dial to a second gripping device on the same or different linear motor conveyor system using a similar method.

Again, while the above method is specifically described with object handoff occurring between the linear motor conveyor system and the rotary dial, it will also be appreciated that the method for object handoff may be performed between two linear motor conveyor systems, or between two rotary dials, or between an arrangement with multiple rotary dials and/or linear motor conveyor systems.

As described above, an automated application may comprise a combination of different continuous motion machines with a layout that allows for the creation of gaps and the recirculation of parts without the need for additional mechanisms or dedicated return paths. Providing a configuration where one of the machines is asynchronous, and one of the gripping devices is programmable, sufficient synchronization can be programmed/controlled by the control system for object handoff, while also enabling handoff omissions and recirculation of parts.

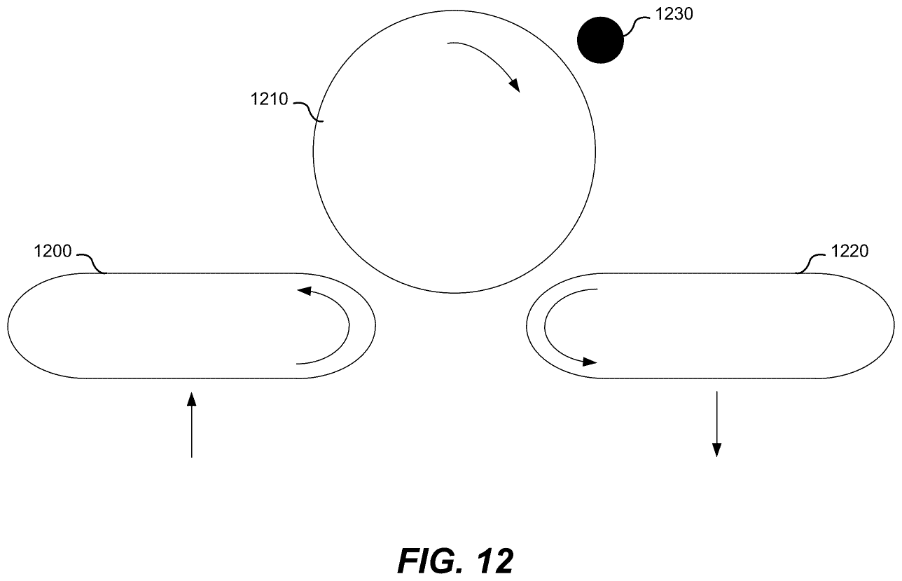

FIG. 12 depicts a schematic representation of an object handling system comprising two linear motor conveyor systems and a rotary dial, which supports high speed object handoff and controlled handoff omissions for recirculating parts. In FIG. 12, there is a first linear motor conveyor system 1200, a rotary dial 1210, and a second linear motor conveyor system 1220. It will also be appreciated that there may be various types of alternative implementations possible.

In this example configuration of an object handling system, one example of object handling may be as follows. An object is received or picked-up by a gripping device at the first linear motor conveyor system 1200. The first linear motor conveyor system 1200 translates the shuttle with the gripping device holding the object counter-clockwise, and hands off the object to the rotary dial 1210, rotating clockwise. The rotary dial 1210 rotates the object. Somewhere along the periphery of the dial 1210 there may be a functional station 1230, such as a camera system for inspecting the object, a labelling system for labelling the object, a high-voltage leak detection system, etc. After rotating around the dial 1210 and passing by the functional station 1230, the object can be handed off to a gripping device on the second linear motor conveyor 1220, rotating counter-clockwise, which translates the object to the next stage of the process. When transferring an object between two gripping devices, the handoff typically happens very quickly and therefore some speed mismatch may be tolerated, however the linear velocity of both grippers during handing off should be reasonably close.

Sometimes, there may be a situation where the functional station 1230 has a failure, but the process could be repeated the next time the object comes around the dial. In this situation when the unprocessed object arrives at the object handoff region between the rotary dial 1210 and the second linear motor conveyor system 1220, it would be desirable to keep the object on the rotary dial 1210 for recirculation. Accordingly, the handoff can be omitted by not actuating the gripping device on the rotary dial 1210. Furthermore, the shuttle on the track of the second linear motor conveyor system 1220 supporting the second gripping device may be controlled to prevent object handoff since handoff won't occur, such as by holding the shuttle back on the track from the handoff region, and/or by not actuating the gripping device on the shuttle (such as by moving the cam out of position). In addition, a gripping device holding a new object on the first linear motor conveyor system 1200 to be transferred to the rotary dial 1210 may also be held back so that the gripping device on the rotary dial 1210 holding the unprocessed part can be recirculated.

Accordingly, in some aspects, such as with an object handling system configured as shown in FIG. 12, a method of performing object handoff may further comprise moving the object around the rotary dial 1210; recirculating the object on the rotary dial 1210; and controlling a second gripping device on a second linear motor conveyor system 1220 to prevent object handoff from the gripping device on the rotary dial 1210. Further, the gripping devices on the linear motor conveyor system 1200 can be controlled to prevent object handoff to the gripping device on the rotary dial 1210 during recirculation.

It would be appreciated by one of ordinary skill in the art that the system and components shown in the figures may include components not shown in the drawings. For simplicity and clarity of the illustration, elements in the figures are not necessarily to scale, are only schematic and are non-limiting of the elements structures. It will be apparent to persons skilled in the art that a number of variations and modifications can be made without departing from the scope of the invention as described herein.

It is contemplated that any part of any aspect or embodiment discussed in this specification can be implemented or combined with any part of any other aspect or embodiment discussed in this specification.

It should be recognized that features and aspects of the various examples provided above can be combined into further examples that also fall within the scope of the present disclosure.

When used in this specification and claims, the terms “comprises” and “comprising” and variations thereof mean that the specified features, steps, or components are included. The terms are not to be interpreted to exclude the presence of other features, steps, or components.

The invention may also broadly consist in the parts, elements, steps, examples and/or features referred to or indicated in the specification individually or collectively in any and all combinations of two or more said parts, elements, steps, examples, and/or features. In particular, one or more features in any of the embodiments described herein may be combined with one or more features from any other embodiment(s) described herein.

1. An object handling system, comprising:
a rotary dial defining a periphery;
a plurality of first gripping devices supported by the rotary dial at circumferentially spaced locations about the periphery;
a linear motor conveyor system comprising one or more second gripping devices arranged thereon; and
a control system configured to control actuation of the plurality of first gripping devices and the one or more second gripping devices to grip and to release an object in synchronization with movement of the rotary dial and the linear motor conveyor system, and to enable object handoff between a first gripping device and a second gripping device,
wherein the plurality of first gripping devices comprise a rotatable linear actuator coupled to a gripping unit that is configured to be rotated and to be actuated between open and closed positions by a drive shaft to grip the object.

2. The object handling system of claim 1, wherein the rotatable linear actuator comprises:
an actuator body;
the drive shaft arranged within the actuator body, the drive shaft having a longitudinal axis and configured to be linearly actuated along and rotatable around the longitudinal axis within the actuator body, wherein the drive shaft is configured to be coupled at a first end thereof to a linearly actuated component that is configured to receive linear and rotational movement;
one or more permanent magnets coupled to the drive shaft and magnetized in a radial direction about the longitudinal axis; and
one or more electric coils disposed within the actuator body around the one or more permanent magnets and configured to receive an electric current that interacts with a magnetic field of the one or more permanent magnets to generate an axial force to linearly actuate the drive shaft.

3. The object handling system of claim 2, further comprising an electric motor disposed within the actuator body and configured to rotate a rotationally actuated component.

4. The object handling system of claim 2, wherein the gripping unit comprises a hub that is the linearly actuated component coupled to the drive shaft, and two or more gripper jaws coupled to the hub and that actuate between the open and closed positions when the hub is linearly actuated by the drive shaft.

5. The object handling system of claim 4, wherein the hub comprises angled slots, and wherein the two or more gripper jaws are each coupled to a roller disposed within a respective angled slot, wherein linear actuation of the hub causes movement of the roller within the respective angled slot and actuation of the corresponding gripper jaw.

6. The object handling system of claim 5, wherein the two or more gripper jaws are pivotally coupled to a gripper housing, and wherein the gripper housing is rotationally actuated.

7. The object handling system of claim 5, wherein the two or more gripper jaws are coupled to a linear rail perpendicular to the longitudinal axis of the drive shaft.

8. The object handling system of claim 1, wherein the first and second gripping devices are the same type of gripping devices or are different types of gripping devices.

9. The object handling system of claim 1, wherein the one or more second gripping devices comprise a parallel gripping device with at least two linearly actuatable gripper fingers for gripping the object.

10. The object handling system of claim 1, wherein the one or more second gripping devices comprise a pivotable gripping device with at least two pivotably actuatable gripper fingers for gripping the object.

11. The object handling system of claim 1, wherein the second gripping devices are actuated via a cam coupled to a drive shaft.

12. The object handling system of claim 11, wherein the second gripping devices are actuated by interacting with the cam while the control system controls the second gripping devices to move along the track.

13. The object handling system of claim 12, wherein the cam is linearly actuatable to move into or out of a position for interacting with a cam follower of the second gripping devices.

14. The object handling system of claim 1, wherein the object is transferred from the linear motor conveyor system to the rotary dial and from the rotary dial to a same or different linear motor conveyor system.

15. The object handling system of claim 1, wherein the plurality of first gripping devices supported by the rotary dial and the one or more second gripping devices arranged on the linear motor conveyor system have a matching pitch between adjacent gripping devices in an object handoff region.

16. The object handling system of claim 1, wherein the first and second gripping devices have an opening that is adjustable to grip objects of varying sizes, and wherein the object handling system comprises a plurality of objects of at least two different sizes at a given time.

17. The object handling system of claim 1, wherein the object handling system runs at 600 parts per minute or greater.

18. The object handling system of claim 1, wherein the object is a syringe, a cartridge, or a vial.

19. The object handling system of claim 1, wherein the object is a vial, and wherein the rotary dial is part of a labelling system, a vision inspection system, or a high-voltage leak detection system.

20. The object handling system of claim 1, wherein the rotary dial is in continuous motion and the linear motor conveyor system is asynchronous and allows independent control of the one or more second gripping devices arranged thereon.
